(19) United States
(12) Patent Application Publication
(10) Pub. No.: US 2011/0143206 A1
(43) Pub. Date: Jun. 16, 2011

(54) ELECTRODE FOR RECHARGEABLE BATTERIES USING AQUEOUS BINDER SOLUTION FOR LI-ION BATTERIES

(75) Inventors: Milburn Ebenezer Jacob Muthu, Breinigsville, PA (US); Monira Mamari, Allentown, PA (US)

(73) Assignee: INTERNATIONAL BATTERY, INC., Allentown, PA (US)

(21) Appl. No.: 12/836,126

(22) Filed: Jul. 14, 2010

(51) Int. Cl. H01M 4/48; H01B 1/24; H01M 4/04

(52) U.S. Cl. 429/231; 252/182.1; 252/509; 252/506; 427/77

(57) ABSTRACT

An electrode mix includes an active material, a water soluble binder, a water soluble thickener, and a sufficient amount of a material selected from the group consisting of ZnO, In₂O₃, SnO₂, Y₂O₃, La₂O₃, Li₂TiO₃, CaTiO₃, BaTiO₃, SrO, CO₃(PO₄)₂, carbon and combinations thereof, to reduce the pH of the mix to between about 7 and about 12. Active material containing low pH can also be used in the electrode process. A method of making an electrode using this material is also provided.

### CROSS-REFERENCE TO RELATED APPLICATION

The entire disclosure of U.S. patent application Ser. No. 12/701,001, filed on Feb. 5, 2010, and owned by the Assignee of the present invention, is incorporated herein by reference in its entirety.

### FIELD OF INVENTION

The present invention relates to an electrode that uses a water soluble binder for use in a rechargeable lithium ion battery and the battery in which the electrode is used.

### BACKGROUND

Li-ion batteries use polymer binders in the fabrication of electrodes. The binders commonly used in Li-ion batteries are polyvinyledene fluoride (PVDF), ethylene-propylene and a diene monomer (EPDM). These polymers are generally insoluble in water. Organic solvents are used to dissolve the polymers and also act as a dispersion medium for the active materials. Some disadvantages of using organic solvents are relatively high cost, environmental impact, and disposal issues. Further, PVDF is highly unstable and tends to break down at high temperatures.

Water soluble binders may be used as an alternative to organic solvent soluble polymeric binders. A water soluble binder-based process may have high potential for industrial process but it has been limited due to a problem with active material dissolution and difficulty in dispersing the active material in the slurry due to high pH. The high pH affects the surface characteristics of the oxide cathodes and also the micro-structure of aluminum current collector. The high pH results in poor dispersion and adhesion between current collector and active materials, which results in poor cell performance.

It would be beneficial to provide an electrode mix that has a water soluble polymer binder, active material and conductivity additive mix and has a pH lower than 12 to prevent the corrosion of the current collector, provide good dispersion, and exhibit low active material dissolution.

### SUMMARY

Briefly, the present invention provides an electrode mix comprising an active material, a water soluble binder, and a sufficient amount of a material selected from the group consisting of ZnO, In₂O₃, SnO₂, Y₂O₃, La₂O₃, Li₂TiO₃, CaTiO₃, BaTiO₃, SrO, CO₃(PO₄)₂, carbon and combinations thereof coated on the active material, to reduce the pH of the mix to between about 10 and about 12. Active material containing low pH can also be used for this process without a surface coating. Carbon coating of active material can also be used to reduce the pH.

The invention further provides a method of manufacturing an electrode according to the steps of: providing an positive electrode slurry having a pH between about 10 and about 12 or surface coating the active material with a ceramic material selected from the group consisting of ZnO, In₂O₃, SnO₂, Y₂O₃, La₂O₃, Li₂TiO₃, CaTiO₃, BaTiO₃, SrO, CO₃(PO₄)₂ and carbon to lower the pH; making a slurry from the active material, a water soluble binder, and water; coating the current collector with the slurry; and drying the slurry to remove the water.

The present invention also provides an electrode manufactured according to the method recited above.

### BRIEF DESCRIPTION OF THE DRAWINGS

The foregoing summary, as well as the following detailed description of the invention, will be better understood when read in conjunction with the appended drawings. For the purpose of illustrating the invention, there is shown in the drawings a certain embodiment of the present invention. It should be understood, however, that the invention is not limited to the precise arrangements and instrumentalities shown. In the drawings:

FIG. 1 is a schematic view of a battery formed in a jellyroll configuration according to an exemplary embodiment of the present invention;

FIG. 1A is a schematic view of the battery of FIG. 1 with the electrolyte;

FIG. 2 is a cross-sectional representation of a prismatic electrochemical cell according to an exemplary embodiment of the present invention;

FIG. 3 is a schematic representation of a positive electrode, a separator and a negative electrode-bi-cell configuration of the exemplary embodiment illustrated in FIG. 1;

FIG. 4 is a flow chart illustrating an exemplary method of manufacturing an electrode according to an exemplary embodiment of the present invention;

FIG. 5 is a Charge/discharge curve for a LiNiCoAlO₂ cathode manufactured according to an exemplary embodiment of the present invention;

FIG. 6 is a Charge/discharge curve for a low pH LiNiCoAlO₂ cathode manufactured according to an exemplary embodiment of the present invention;

FIG. 7 is a Charge/discharge curve for a ZnO coated LiNiCoAlO₂ cathode manufactured according to an exemplary embodiment of the present invention; and

FIG. 8 is a life cycle curve for low pH LiNiCoAlO₂ and Lithium half cell manufactured according to an exemplary embodiment of the present invention.

### DETAILED DESCRIPTION OF THE PREFERRED EMBODIMENTS

In describing the embodiments of the invention illustrated in the drawings, specific terminology will be used for the sake of clarity. However, the invention is not intended to be limited to the specific terms so selected, it being understood that each specific term includes all technical equivalents operating in a similar manner to accomplish a similar purpose. It is understood that the drawings are not drawn exactly to scale.

The following describes particular embodiments of the present invention. It should be understood, however, that the invention is not limited to the embodiments detailed herein. Generally, the following disclosure refers to electrodes for rechargeable lithium ion batteries and a method for making electrodes, although the inventive electrodes are not necessarily limited to only lithium ion batteries.

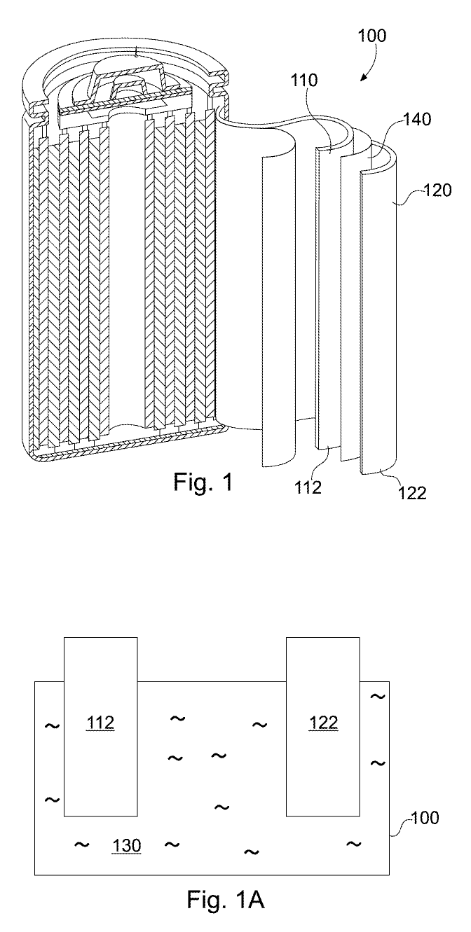

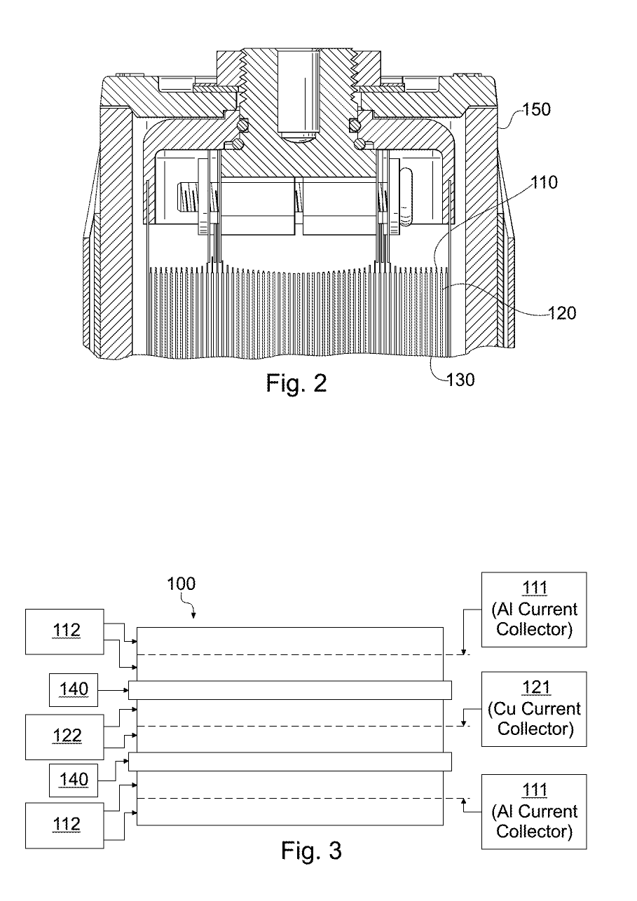

Referring to FIGS. 1 and 1A, a rechargeable battery 100 according to an exemplary embodiment of the present invention is shown. Battery 100 includes a positive electrode 112 formed from a positive electrode mix 110, a negative electrode 122 formed from a negative electrode mix 120, and an electrolyte 130. While FIG. 1 illustrates battery 100 formed in a “jellyroll” configuration, those skilled in the art will recognize that other formations, such as, for example, a prismatic configuration, which is illustrated in FIG. 2, may also be used within the teaching of the present invention.

Positive electrode mix 110 exhibits a reduction potential and negative electrode mix 120 has an oxidation potential. Electrolyte 130 transfers ions between positive electrode mix 110 and negative electrode mix 120 within battery 100. Separator 140 separates positive electrode mix 110 from negative electrode mix 120.

The present invention uses a ceramic coating on the positive electrode mix 110 in order to reduce the pH of positive electrode mix 110. The pH of a prior art, comparative slurry without the inventive ceramic coating is above 12 for a lithium nickel cobalt aluminum cell and between about 11.5 and about 12 for a lithium nickel manganese cobalt cell. The high pH of the prior art slurry attacks the aluminum current collector immediately after contacting the surface during the coating process and increases the resistance of the coated electrode, thereby reducing the overall cell performance. The high pH also affects the active material dispersion and adhesion.

Positive electrode mix 110 includes positive electrode active material selected from the group consisting of LiNi_{y}COₓM_{z}O₂, where M is selected from the group consisting of Mn, Al, Sn, In, Ga and Ti and 0.15<x<0.5, 0.5<y<0.8 and 0<z<0.15 and Li[Li_{(1-2y)/3}Ni_{y}Mn_{(2-y/3)}]O₂, Li[Li_{(1-y)/3}Co_{y}Mn_{(2-2y)/3}]O₂ and Li[Ni_{y}CO_{1-2y}Mn_{y}]O₂ where x=(2−y)/3, 0<y<0.5, LiNiCoO₂MnO₂, Li_{1+y}[Ni_{1/3}CO_{1/3}Mn_{1/3}]_{1-y}O₂, 0<x<0.33, 0<y<0.15 where y=(x/2+x), xLi₂MnO₃, (1−x)Li[NiCoMn]O₂, Li_{(1+y)}[Ni_{0.5}Co_{0.2}Mn_{0.3}]_{1-y}O₂, 0<x<0.3, 0<y<0.130, where y=(x/2+x), and combinations thereof. In an exemplary embodiment, the positive electrode active material is between about 70 percent and about 95 percent (by weight) of the positive electrode mix 110. The remaining portion of positive electrode mix 110 may be a conductive additive, binder and thickener.

The positive active material, in a powder form, is coated with a surface coating of a ceramic to reduce the pH of the resulting slurry when the coated electrode mix is mixed with a water soluble binder, water, and a water soluble thickener, if necessary. The surface coating includes an oxide material selected from the group consisting of ZnO, In₂O₃, SnO₂, Y₂O₃, La₂O₃, Li₂TiO₃, CaTiO₃, BaTiO₃, SrO, CO₃(PO₄)₂ and carbon or a combination thereof. The surface coating is between about 1 mole percent and about 10 mole percent and most preferably between about 1 mole percent and about 3 mole percent. If the surface coating exceeds about 10 mole percent, electrode performance is reduced considerably due an increase in electrical resistance of the surface coating. The increase in resistance is specifically for ceramic coating.

A positive electrode material having a pH between about 7 and about 12, such as, for example, low pH LiNiCoAlO₂ material supplied by Toda Inc, Japan, may be used. In such a case, the surface coating may be eliminated.

Positive electrode mix 110 also includes a water soluble aqueous binder selected from the group consisting of poly(acrylonitrile-co-acrylamide)polymer, carboxymethylcellulose, (CMC), poly vinyl alcohol, polyvinylpyrrolidone, poly acrylic acid, polymethacrylic acid, polyethylene oxide, polyacrylamide, poly-N-isopropylacrylamide, Poly-N,N-dimethylacrylamide, polyethyleneimine, polyoxyethylene, polyvinylsulfonic acid, poly(2-methoxyethoxyethoxyethylene), styrene butadiene rubber (SBR), butadiene-acrylonitrile, rubber (NBR), hydrogenated NBR (HNBR), epichlorhydrin rubber (CHR), acrylate rubber (ACM), poly(allylamine), xanthan gum, guar gum, chitosan, polyvinyl acetate, gelatin, casein, a cellulose from the group consisting of natural cellulose, physically and/or chemically modified cellulose, natural polysaccharides, chemically and/or physically modified polysaccharides, hydroxy methyl cellulose and methyl ethyl hydroxy cellulose, and a poly(carboxylic acid). Some examples of this poly(carboxylic acid) are: polylactic acid (PLA), polyacrylic acid, polysuccinic acid, poly maleic acid and anhydride, poly furoic (pyromucic acid), poly fumaric acid, poly sorbic acid, poly linoleic acid, poly linolenic acid, poly glutamic acid, poly methacrylic acid, poly licanic acid, poly glycolic acid, poly aspartic acid, poly amic acid, poly formic acid, poly acetic acid, poly propoionic acid, poly butyric acid, poly sebacic acid, and copolymers thereof. When using poly(carboxylic acids), lithium hydroxide or suitable material is used to neutralize the pH of the binder solution. The binder is used to bind the positive electrode active material and the conductive additive together with water to form a slurry.

Positive electrode mix 110 further includes a water soluble thickener that may be selected from the group consisting of natural cellulose, physically and/or chemically modified cellulose, natural polysaccharides, chemically and/or physically modified polysaccharides, carboxymethyl cellulose, hydroxy methyl cellulose and methyl ethyl hydroxy cellulose. The thickener is used to control the viscosity of the slurry. Optionally, such as, for example, if a poly(acrylonitrile-co-acrylamide)polymer or other sufficiently viscous polymer is used as the binder, a thickener may not be necessary and may be omitted from the slurry.

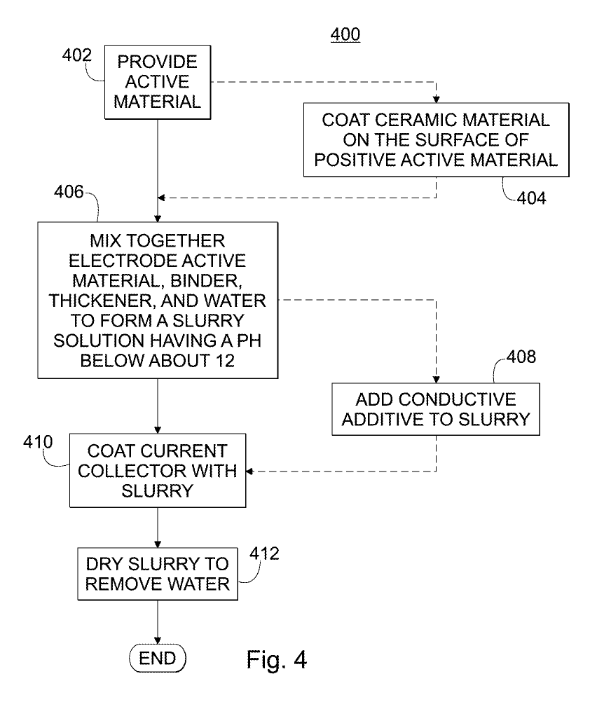

In an exemplary embodiment illustrated in the flowchart 400 of FIG. 4, in step 402, the active material is provided. In step 404, the ceramic material is coated on the surface of the positive active material either by a solid state process or a solvent based process, both of which are known by those having ordinary skill in the art. The positive active material may be mixed with the different surface coating oxide materials listed above in different molar ratios or weight ratios to achieve a desired pH. The mixture may be either mechanically blended or pulverized. The positive active material and the ceramic mix is heat treated at an appropriate temperature, such as, for example, between about 400 degrees Celsius and about 500 degrees Celsius to make a final product. Alternatively, other known coating methods may be used. Step 404 may be omitted if a positive active material having a sufficiently low pH is used.

In step 406, the coated positive electrode active material, the binder, the thickener, and water are mixed together to form a slurry solution having a pH below about 12, and in an exemplary embodiment, a pH between about 7 and about 12. More preferably, positive electrode active material, the binder, the thickening agent, and water are mixed together to form a solution having a pH below about 11.8, and in an exemplary embodiment, a pH between about 10 and about 11.5. The pH can be controlled by coating a desired amount of surface coating material onto the active material.

In step 408, a conductive additive may optionally be added to the slurry. The conductive additive may be selected from the group consisting of carbon black, graphite, acetylene black and combinations thereof. The conductive additive enhances the electronic conductivity of the electrode mix. In an exemplary embodiment, the conductive additive material is between about 1 percent and about 10 percent (by weight) of the positive electrode mix 110, and more preferably, between about 1 percent and about 5 percent by weight.

In step 410, the slurry is coated on an aluminum or nickel current collector or a carbon coated aluminum current collector to form positive electrode 112. In step 412, the slurry is then dried to remove the water. The moisture content after drying the slurry is preferably less than 2000 parts per million (ppm), more preferably less than 1000 ppm, and even more preferably less than 200 ppm.

Negative electrode 122 is manufactured using a similar process to that described above for positive electrode 112. In an exemplary embodiment, negative active material from the group consisting of graphite, hard carbon, silicon, tin and alloys of silicon and tin and lithium titanate may be used to form negative active materials.

Negative electrode mix 120 is formed in a slurry of the negative active material, the binder and thickener described above with respect to positive electrode mix 110, water, and an optional conductive additive described above.

The slurry containing negative electrode mix 120 is coated on a copper current collector to form negative electrode 122. Aluminum current collector can also be used for lithium titanate based negative active material. The slurry is then dried to remove the water. The moisture content after drying the slurry is preferably less than 500 ppm and more preferably less than 200 ppm.

### Example 1

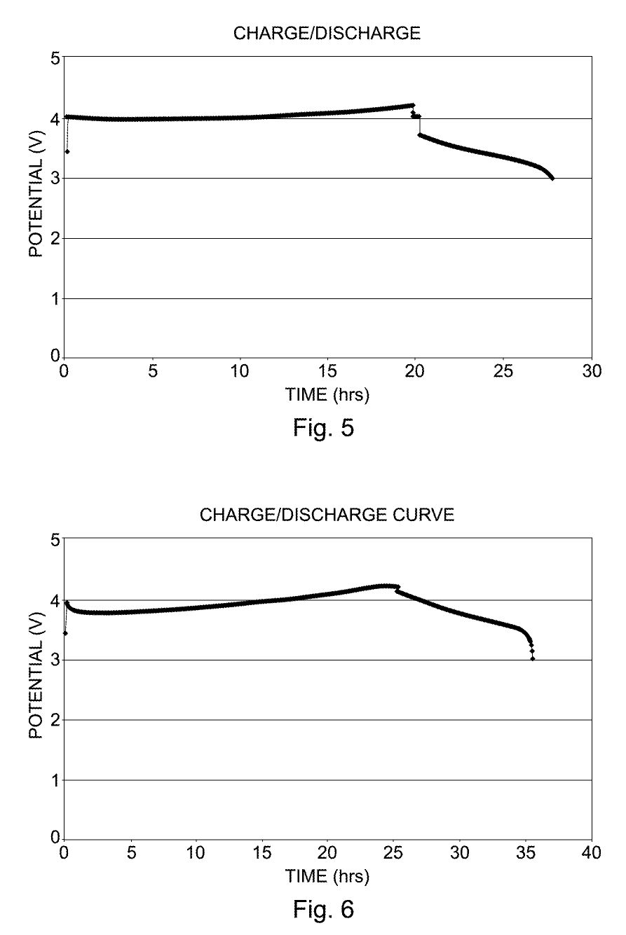

Positive electrode mix 110 was prepared first by dissolving poly (acrylonitrile-co-acrylamide) polymer binder (supplied by Chengduo Indigo Power Sources Co., Ltd, China) in a ratio of between about 80 and about 85 percent water and between about 15 and about 20 percent binder. A positive active powder of high pH LiNiCoAlO₂ (supplied by Toda America, Inc.) with an appropriate amount (between about 3 and about 6 weight percent) of a conductive additive, such as for example Super P®, manufactured by Timcal Graphite & Carbon located in Switzerland, was mixed with the binder in water solution for about 2 hours. The pH of the slurry for LiNiCoAlO₂ positive mix was between about 11.5 and about 12.5. The homogeneously mixed slurry was then coated on an aluminum current collector 111 to form positive electrode 112. Positive electrode 112 was cut into an appropriate size and dried in a vacuum oven until the moisture was below about 1000 ppm and most preferably below about 200 ppm. The charge/discharge curve for LiNiCoAlO₂/Lithium metal show poor performance because of high pH (FIG. 5).

### Example 2

Positive electrode mix 110 was prepared first by dissolving poly (acrylonitrile-co-acrylamide) polymer binder (supplied by Chengduo Indigo Power Sources Co., Ltd) in water. The ratio of binder to water ranged from between about 15 and about 20 percent. A positive active powder of low pH LiNiCoAlO₂ (supplied by Toda America, Inc.) with an appropriate amount (between about 3 and about 6 weight percent) of a conductive additive, such as for example Super P®, was mixed with the binder in water solution for about 2 hours. The pH of the slurry for the low pH LiNiCoAlO₂ positive mix was between about 11 and about 12. The homogeneously mixed slurry was then coated on an aluminum current collector to form positive electrode 112. Positive electrode 112 was cut into an appropriate size and dried in a vacuum oven until the moisture was below about 1000 ppm and most preferably below about 200 ppm. The charge/discharge curve for low LiNiCoAlO₂/Lithium metal show excellent performance because of low pH (FIG. 6).

### Example 3

Positive electrode mix 110 was prepared first by dissolving poly (acrylonitrile-co-acrylamide) polymer binder (supplied by Chengduo Indigo Power Sources Co Ltd) in water. The ratio of binder to water ranged from between about 15 and about 20 percent. A ZnO coated positive active powder LiNiCoAlO₂ (supplied by NEI Inc, USA) with an appropriate amount (between about 3 and about 6 weight percent) of a conductive additive, such as for example Super P®, was mixed with the binder in water solution for about 2 hrs. The pH of the slurry for ZnO coated LiNiCoAlO₂ positive mix was between about 11 and about 12. The homogeneously mixed slurry was then coated on an aluminum current collector to form positive electrode 112. Positive electrode 112 was cut into an appropriate size and dried in a vacuum oven until the moisture was below about 1000 ppm and most preferably below about 200 ppm.

Negative electrode mix 120 was prepared first by dissolving poly (acrylonitrile-co-acrylamide) polymer binder (supplied by Chengduo Indigo Power Sources Co. Ltd) in water. The ratio of binder to water ranged from between about between about 15 and about 20 percent. A negative active powder (graphite) with an appropriate amount (between about 1 and about 6 weight percent) of conductive additive (Super P®) was mixed with the binder in water solution and mixed for about 2 hours. The pH of the slurry was between about 7 and about 9. The homogeneously mixed slurry was then coated onto copper current collector 121 to form negative electrode 122. Negative electrode 122 was cut into an appropriate size and dried in a vacuum oven until the moisture was below about 1000 ppm and most preferably below about 200 ppm. The cells were built as described in FIGS. 2 and 3. The cells were then filled with electrolyte 130. The lithium half cells were charge/discharged for capacity.

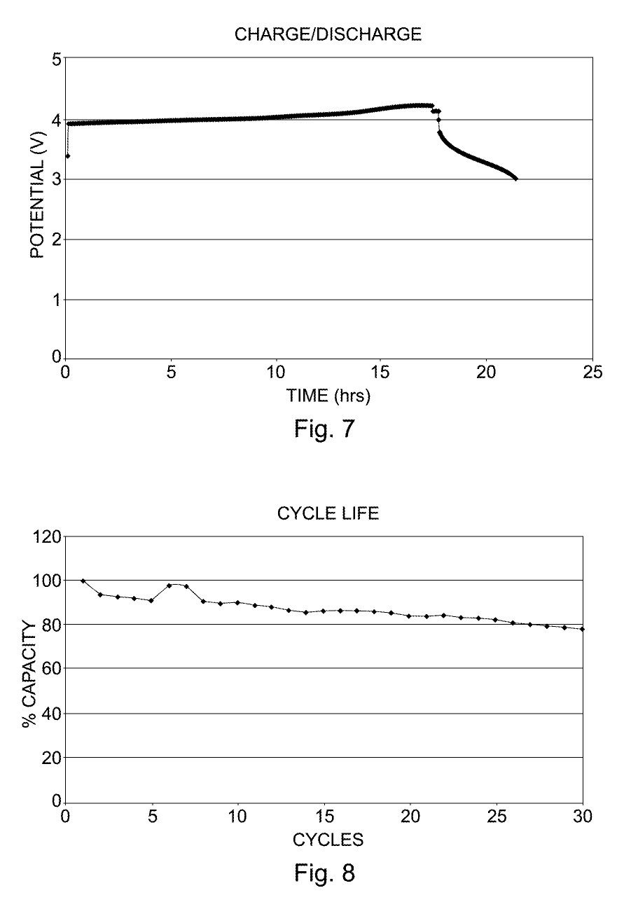

FIGS. 5-7 are exemplary Charge/discharge curves for a LiNiCoAlO₂ cathode manufactured according to an exemplary embodiment of the present invention vs. lithium metal, a low pH LiNiCoAlO₂ cathode manufactured according to an exemplary embodiment of the present invention, and a ZnO coated LiNiCoAl₂ cathode manufactured according to an exemplary embodiment of the present invention, respectively. FIG. 8 is a cycle life curve for low pH LiNiCoAlO₂ cathode battery according to the present invention.

While the principles of the invention have been described above in connection with preferred embodiments, it is to be clearly understood that this description is made only by way of example and not as a limitation of the scope of the invention.

1. An electrode mix comprising:
a water soluble binder; and
an active material coated in a sufficient amount of a coating material selected from the group consisting of ZnO, In₂O₃, SnO₂, Y₂O₃, La₂O₃, Li₂TiO₃, CaTiO₃, BaTiO₃, SrO, CO₃(PO₄)₂, carbon and combinations thereof, to provide a pH of the mix below about 12.

2. The electrode mix according to claim 1, wherein the amount of the coating material is sufficient to provide the pH of the mix between about 10 and about 12.

3. The electrode mix according to claim 1, further comprising a water soluble thickener.

4. The electrode mix according to claim 1, wherein the water soluble binder comprises a polyacrylonitrile-acrylamide polymer and water.

5. The electrode mix according to claim 1, wherein the active material is selected from the group consisting of LiNi_{y}COₓM_{z}O₂, where M is selected from the group consisting of Mn, Al, Sn, In, Ga and Ti and 0.15<x<0.5, 0.5<y<0.8 and 0<z<0.15 and Li[Li_{(1-2y)/3}Ni_{y}Mn_{(2-y)/3}]O₂, Li[Li_{(1-y)/3}CO_{y}Mn_{(2-2y)/3}]O₂ and Li[Ni_{y}CO_{1-2y}Mn_{y}]O₂ where x=(2−y)/3, 0<y<0.5, LiNiCoO₂MnO₂, Li_{1+y}[Ni_{1/3}CO_{1/3}Mn_{1/3}]_{1-y}O₂, 0<x<0.33, 0<y<0.15 where y=(x/2+x), xLi₂MnO₃, (1−x)Li[NiCoMn]O₂, Li_{(1+y)}[Ni_{0.5}Co_{0.2}Mn_{0.3}]_{1-y}O₂, 0<x<0.3, 0<y<0.130, where y=(x/2+x), and combinations thereof.

6. The electrode mix according to claim 1, wherein the coating material consists of ZnO.

7. The electrode mix according to claim 1, wherein the coating material consists of In₂O₃.

8. The electrode mix according to claim 1, wherein the coating material consists of SnO₂.

9. The electrode mix according to claim 1, wherein the coating material consists of Y₂O₃.

10. The electrode mix according to claim 1, wherein the coating material consists of La₂O₃.

11. The electrode mix according to claim 1, wherein the coating material consists of Li₂TiO₃.

12. The electrode mix according to claim 1, wherein the coating material consists of CaTiO₃.

13. The electrode mix according to claim 1, wherein the coating material consists of SrO.

14. The electrode mix according to claim 1, wherein the coating material consists of CO₃(PO₄)₂.

15. The electrode mix according to claim 1, wherein the coating material consists of carbon.

16. (canceled)

17. A method of manufacturing an electrode according to the steps of:
a) providing an active material having a pH lower than about 12;
b) making a slurry from the active material, a water soluble binder, and water;
c) coating at least part of an electrode with the slurry; and
d) drying the slurry to remove the water.

18. The method according to claim 16, wherein step a) comprises the step of surface coating the active material with a coating material selected from the group consisting of ZnO, In₂O₃, SnO₂, Y₂O₃, La₂O₃, Li₂TiO₃, CaTiO₃, BaTiO₃, SrO, and CO₃(PO₄)₂.

19. The method according to claim 17, wherein step a) comprises coating a sufficient amount of the coating material onto the active material to provide the pH of the slurry between about 10 and about 12.

20. An electrode manufactured according to a method of:
a) providing an active material;
b) surface coating the active material with a coating material selected from the group consisting of ZnO, In₂O₃, SnO₂, Y₂O₃, La₂O₃, Li₂TiO₃, CaTiO₃, BaTiO₃, SrO, and CO₃(PO₄)₂;
c) making a slurry from the coated active material, a water soluble binder, and water;
d) coating at least part of an electrode with the slurry; and
e) drying the slurry to remove the water.

21. An electrode manufactured according to the method of claim 19, wherein step b) comprises coating a sufficient amount of the coating material onto the active material to provide the pH of the slurry between about 10 and about 12.
